(19) United States
(12) Patent Application Publication
(10) Pub. No.: US 2010/0308003 A1
(43) Pub. Date: Dec. 9, 2010

(54) Modular and Natural Infant Feeding Container

(75) Inventors: Jennifer P. Morrill, Emerald Hills, CA (US); Linda H. Pouliot, San Mateo, CA (US); Randi J. Kofman, Lafayette, CA (US)

Correspondence Address: PATENT LAW GROUP LLP, 2635 NORTH FIRST STREET, SUITE 223, SAN JOSE, CA, 95134, US

(73) Assignee: ADIRI, INC., Palo Alto, CA (US)

(21) Appl. No.: 12/478,695

(22) Filed: Jun. 4, 2009

(51) Int. Cl. A61J 9/00; A61J 9/04; A61J 9/08; B65D 83/00

(52) U.S. Cl. 215/11.4; 215/11.5; 215/11.6; 215/388

(57) ABSTRACT

A modular and natural infant feeding container is provided for multiple stages of development. The container includes a rigid cylindrical body, a removable top for securing an open top end of the cylindrical body, and a removable bottom cap for securing an open bottom end of the cylindrical body. The removable top has a dome shaped portion with a ducted nipple. The dome shaped portion has substantially the same outer radius as the cylindrical body. Another removable top may be interchanged with the removable top. The other removable top may include a different nipple, a sippy spout, or a straw passage.

### CROSS REFERENCE TO RELATED APPLICATION

This application is related to U.S. patent application Ser. No. ______, entitled “Cap for Sealing Nipple,” which is concurrently filed on ______ and incorporated herein by reference.

### FIELD OF INVENTION

The present invention relates to infant feeding containers, more specifically to one with a natural and modular design that can be used for multiple stages of development.

### DESCRIPTION OF RELATED ART

It is widely known that natural breast feeding is the best way to nurture an infant. The quality of mother's milk may be superior to prepared formulas and the act of providing an infant with the mother's warm breast and comfort is an important aspect of bonding between mother and infant. However, artificial feeding systems may be desirable or necessary in some circumstances. These include medical situations such as premature births, mothers who have had mastectomies or who are unable to lactate sufficiently, infants who require dietary supplements, and health problems such as cleft pallet or breast abscesses. Social situations requiring artificial feeding include employed women who are unable to feed their infants at work, women who use breast pumps and require containers for feeding, the need to feed adopted infants, and other medical or social situations that may recommend the use of an artificial container.

Healthcare professionals agree that an infant's sensory experience is particularly important in the formative stages of development, and especially in the feeding process. Many of the conventional baby bottles may be cited for various shortcomings, the greatest being the unnatural sensory experience they provide, particularly for newborn infants. Although artificial nipples are typically soft, they do not provide a sensory experience similar to the comforting feeling of breast feeding where an infant is often in full contact with the mother's soft, warm breast. While artificial feeding containers can never fully imitate a mother, the commonly assigned U.S. Pat. Nos. 5,690,679 and 5,993,479, and U.S. patent application Ser. No. 11/539,572 (Attorney Docket No. ADI-P101) disclose designs that offer the combination of form, feel, and function that provide a far more natural sensory experience for infants when artificial feeding means are needed.

### SUMMARY

In one embodiment of the invention, a modular and natural infant feeding container is provided for multiple stages of development. The container includes a rigid cylindrical body, a removable top for securing an open top end of the cylindrical body, and a removable bottom cap for securing an open bottom end of the cylindrical body. The removable top has a dome shaped portion with a ducted nipple. The dome shaped portion has substantially the same outer radius as the cylindrical body. Another removable top may be interchanged with the removable top. The other removable top may include a different nipple, a sippy spout, or a straw passage.

### BRIEF DESCRIPTION OF THE DRAWINGS

FIG. 1 illustrates an unassembled view of an infant feeding container;

FIG. 2 illustrates an assembled view of the infant feeding container of FIG. 1 without a cover;

FIG. 3 illustrates an exploded view of the infant feeding container of FIGS. 1 and 2 where a top and a bottom cap are further broken down into their components;

FIG. 4 illustrates a cross-section of the infant feeding container of FIGS. 1 and 2 in one embodiment of the invention.

FIG. 5 illustrates a variety of removable tops for the infant feeding container of FIGS. 1 and 2;

FIG. 6 illustrates an unassembled view of another infant feeding container;

FIG. 7 illustrates a cross-section of the infant feeding container of FIG. 6; and

FIG. 8 illustrates a variety of removable tops for the infant feeding container of FIG. 6, all arranged in accordance with embodiments of the present disclosure.

Use of the same reference numbers in different figures indicates similar or identical elements.

### DETAILED DESCRIPTION

A modular and natural infant feeding container is provided for multiple stages of development. The container may be fitted with a pliant top that mimics the shape of a mother's breast; the top is larger than a conventional baby bottle nipple. When filled with a warm liquid, the top provides soft and warm facial contact to an infant during feeding. The top can be made with different flow rates and nipple shapes and sizes to suit the needs of an infant and provide a more natural feeding experience. The container may also be fitted with other tops, including those with a sippy spout or a passage for receiving a straw. This allows the container to be used even as the child transitions away from bottle feeding.

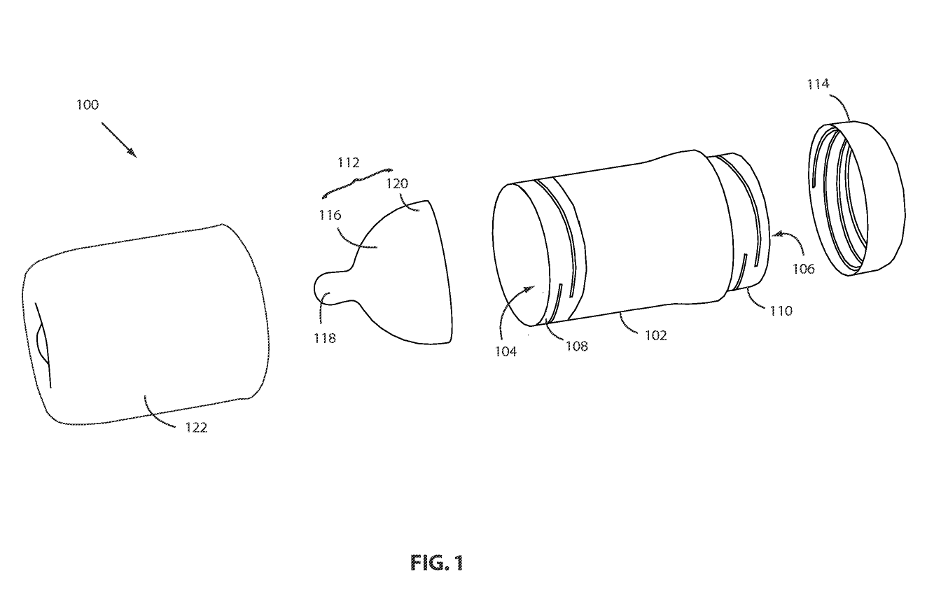

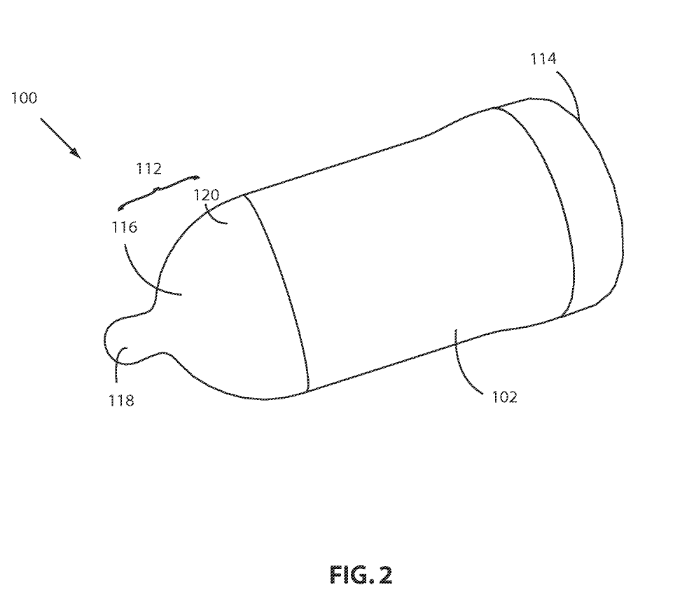

FIGS. 1 and 2 illustrate a modular baby feeding container 100 (e.g., a baby bottle) in one embodiment of the invention. Container 100 includes a generally cylindrical body 102 with top open end 104 and a bottom open end 106. At open end 104, body 102 has a threaded neck 108. At open end 106, body 102 has a threaded neck 110. Body 102 provides a rigid shape that a user can easily grip. The outer surface of body 102 may be tacky to improve grip. The outer surface of body 102 may optionally include dimples, bumps, or other patterns that improve grip. The outer surface of body 102 is marked to indicate the volume of the liquid content in container 100. Body 102 may be a single injection molded part or a double injection molded part with a hard interior and a soft and tacky exterior. Body 102 may be made from nylon, polycarbonate, polysulfone, or another suitable rigid material.

A removable top 112 screws onto open end 104 and a removable bottom cap 114 screws onto open end 106 to secure the liquid content in container 100. Top 112 has a pliant dome shaped portion 116 with a ducted nipple 118 at the crest, and a rigid skirt portion 120 extending and slightly flaring out from up to 10 mm (e.g., 5 mm) the dome shaped portion. Dome shaped portion 116 and skirt portion 120 have substantially the same outer radius as body 102, which can range from 25 to 40 mm (e.g., 35 mm) depending on the embodiment. The inner surface of skirt portion 120 is threaded to engage threaded neck 108 of body 102. Similarly, the inner surface of cap 114 is threaded to engage threaded neck 110 of body 102. A cover 122 fits over container 100 to cover at least part of dome shaped portion 116.

Dome shaped portion 116 is formed in the approximate shape of a breast. Dome shaped portion 116 is greater in size than a conventional baby bottle nipple. When filled with a warm liquid, dome shaped portion 116 provides soft and warm facial contact to an infant during feeding.

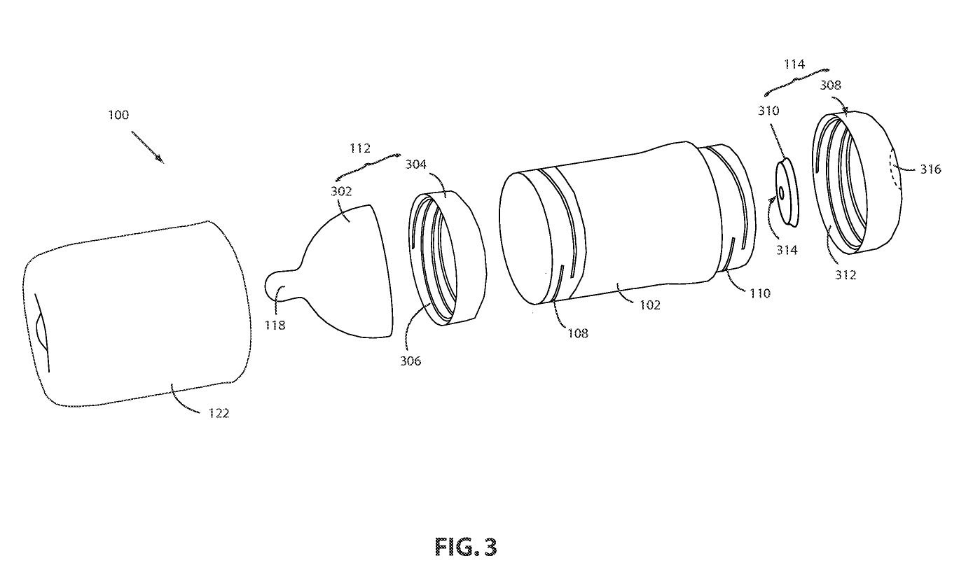

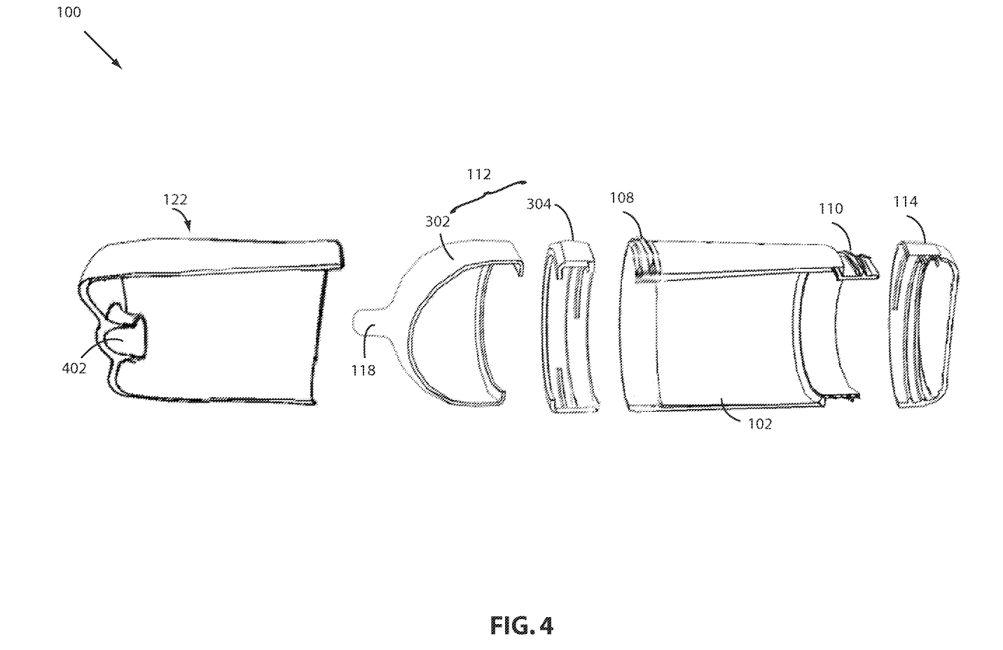

FIGS. 3 and 4 illustrate container 100 where the components of top 112 and cap 114 are illustrated in detail in one embodiment of the invention.

In one embodiment, top 112 is an integral piece made in an over-mold process. Top 112 has a pliant over-mold 302 molded over a rigid cylindrical collar 304. Collar 304 is first molded and then over-mold 302 is molded over the collar. Alternatively top 112 is an elastic fit of two separately made over-mold 302 and collar 304 where the over-mold elastically fits around the collar. The upper part of over-mold 302 unsupported by collar 304 forms the pliant dome shaped portion 116 with ducted nipple 1 18. The lower part of over-mold 302 supported by collar 304 forms the rigid skirt portion 120. Collar 304 has a threaded inner circumferential surface 306 for engaging threaded neck 108. Over-mold 302 may be made from silicone, rubber, latex, thermoplastic elastomer, or another suitable pliant material. Collar 304 may be made from nylon, polycarbonate, polysulfone, or another suitable rigid material.

In one embodiment, cap 114 is an integral piece made in an over-mold process. Cap 114 has a rigid cap body 308 and a pliant cap seal 310 inside the cap body. In one embodiment, cap body 308 is first molded and then cap seal 310 is molded into the cap body. Alternatively cap 114 is an elastic fit to two separately made cap body 308 and cap seal 310 where the cap seal frictionally fits inside cap body 308. Cap body 308 has a threaded inner circumferential surface 312 for engaging threaded neck 110. Cap body 308 may be made from nylon, polycarbonate, acrylic, or other suitable rigid material. Cap seal 310 may be made from thermoplastic elastomer or other suitable pliant material.

Cap seal 310 includes a valve 314 opposite a vent 316 (shown in phantom in FIG. 3) in cap body 308. Valve 314 and vent 316 allow air to enter container 100 as the liquid content exits the container through ducted nipple 118.

Cover 122 fits over container 100 to at least partially enclose dome shaped portion 1 16. Cover 122 has an inner surface that forms a top cap 402 (FIG. 4) for engaging ducted nipple 118 to prevent the liquid content from leaking. For more details regarding cover 122, please refer to U.S. patent application Ser. No. ______, entitled “Cap for Sealing Nipple,” which is concurrently filed on ______ and incorporated by reference.

To fill container 100 from the bottom, the user fits cover 122 over top 112 so that ducted nipple 118 is capped. The user then turns container 100 upside down, unscrews cap 1 14, and fills the container with the liquid content. Once filled, the user screws cap 114 back onto body 102. When container 100 is filled from the bottom, the volume in top 112 is also used to hold the liquid content in addition to the volume in body 102.

To fill container 100 from the top, the user unscrews top 112 and fills the container with the liquid content. Once filled, the user screws top 112 back onto body 102.

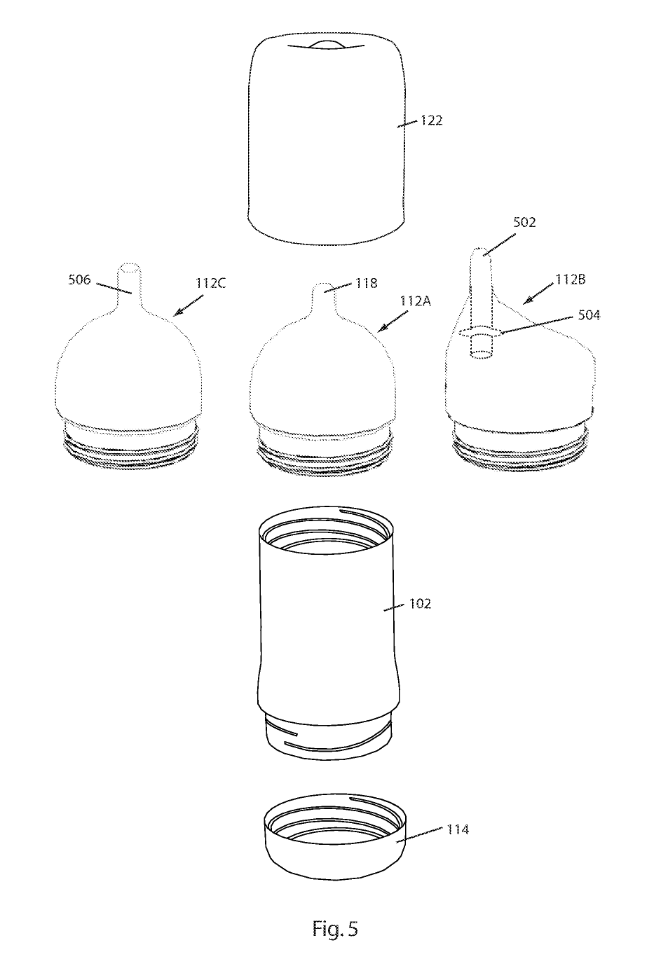

FIG. 5 illustrates a variety of removable tops 112A, 112B, and 112C for container 100 in one embodiment of the invention. Tops 112A, 112B, and 112C have threaded inner circumferential surfaces as described above for top 112. Top 112A represents tops that are shaped like a breast. Top 112A can be made with nipple of different shapes and sizes to provide a feeding experience closely resembling natural breast feeding. Top 112A can be made with ducted nipple of different flow rates that are age appropriate for the infant. Top 112B has a drinking/sippy spout 502 coupled to a valve 504 (shown in phantom) that is normally found in a sippy cup to prevent dripping. Top 112C provides a cylindrical passage 506 for a straw. Tops 112B and 112C could be made either pliant or rigid. Tops 112B and 112C allow container 100 to be used after a child transitions away from bottle feeding in multiple stages of development.

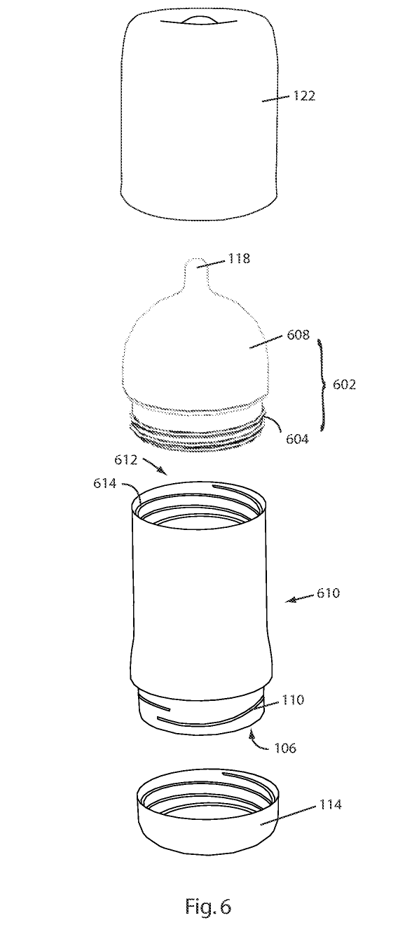

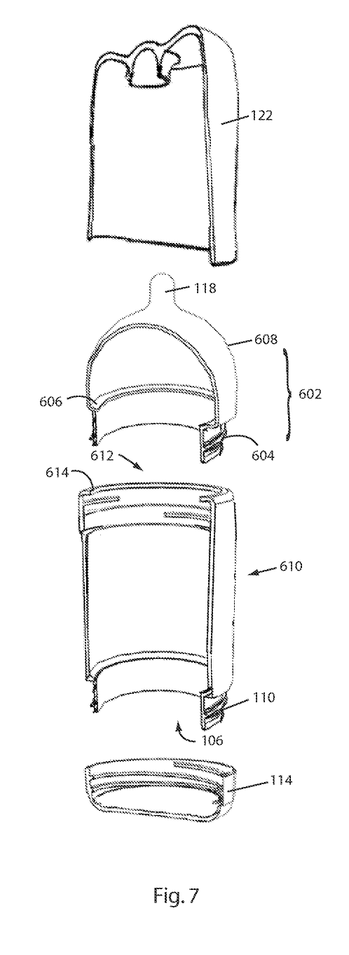

FIGS. 6 and 7 illustrate a modular baby feeding container 600 in one embodiment of the invention. A top 602 includes a rigid threaded neck 604 with a flange 606 above the threads, and a pliant dome shaped portion 608 with a ducted nipple 118. Dome shaped portion 608 has a lower portion that fits around flange 606 (FIG. 7). In one embodiment, top 602 is an elastic fit of two separately made dome shaped portion 608 and neck 604 where the domed shaped portion elastically fits around flange 606. Alternatively top 602 is an integral piece made in an over-mold process where threaded neck 604 is first molded and then dome shaped portion 608 is molded around flange 606. Threaded neck 604 may be made of nylon, polycarbonate, polysulfone, or another suitable rigid material, and dome shaped portion 608 may be made of silicone, rubber, latex, thermoplastic elastomer, or another suitable pliant material.

Like dome shaped portion 116, dome shaped portion 608 is formed in the approximate shape of a breast. Dome shaped portion 608 is greater in size than a conventional baby bottle nipple. When filled with a warm liquid, dome shaped portion 608 provides soft and warm facial contact to an infant during feeding.

A body 610 includes a top open end 612 having a threaded inner circumferential surface 614 for engaging threaded neck 604. Like body 102, body 610 includes a bottom open end 106 with a threaded neck 110 for engaging threaded inner circumferential surface 312 of cap 114.

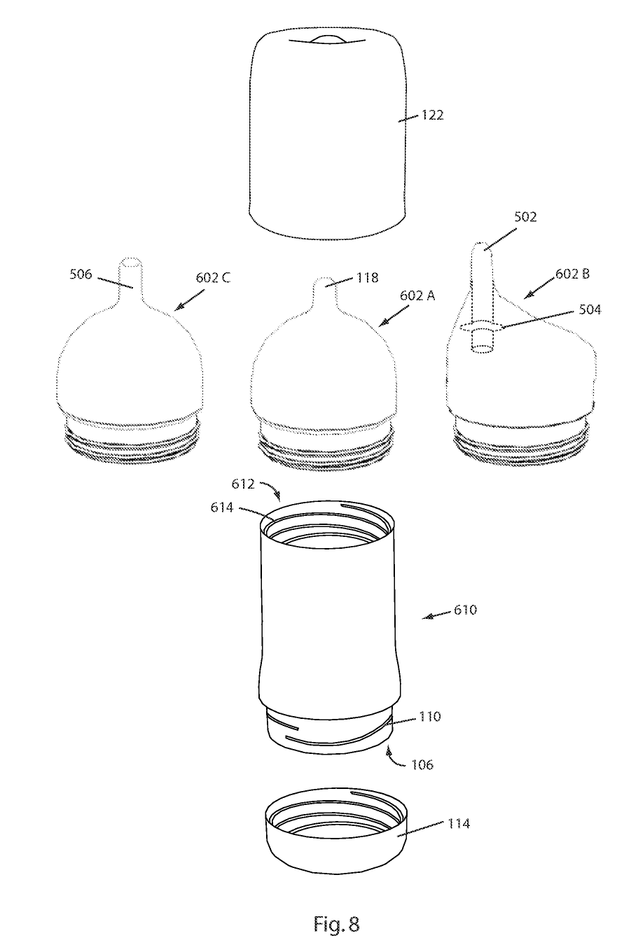

FIG. 8 illustrates a variety of removable tops 602A, 602B, and 602C for container 600 in one embodiment of the invention. Tops 602A, 602B, and 602C have threaded necks as described above for top 602. Like top 112A described above, top 602A represents tops that are shaped like a breast. Like top 112B described above, top 602B has a drinking/sippy spout 502 coupled to a valve 504 (shown in phantom) that prevents dripping. Like top 112C, top 602C provide a cylindrical passage 506 for a straw.

Various other adaptations and combinations of features of the embodiments disclosed are within the scope of the invention. For example, body 102 and bottom cap 114 may be made into an integral unit to reduce the number of components. In such an embodiment, body 102 and cap body 308 would be a single element, and cap seal 310 with vent 314 would be molded into the bottom of the element. However, such an embodiment may reduce the volume of the liquid that may be filled as the volume in top 112 is not available to hold the liquid content when container 100 is filled from the top. Numerous embodiments are encompassed by the following claims.

What is claimed is:

1. A modular infant feeding container, comprising:
a rigid cylindrical body, the cylindrical body defining top and bottom open ends;
a removable top for securing the top open end of the cylindrical body, the removable top comprising a pliant dome shaped portion with a ducted nipple, the plaint dome shaped portion comprising substantially the same outer radius as the cylindrical body; and
a removable bottom cap for securing the bottom open end of the cylindrical body.

2. The infant feeding container of claim 1, further comprising:
an other removable top interchangeable with the removable top, the other removable top comprising a drinking spout and a valve coupled to the drinking spout.

3. The infant feeding container of claim 1, further comprising:
an other removable top interchangeable with the removable top, the other removable top comprising a passage for receiving a straw.

4. The infant feeding container of claim 1, wherein the removable top further comprises a rigid collar, the dome shaped portion having a lower portion around the collar.

5. The infant feeding container of claim 4, wherein the collar comprises a threaded inner surface and the top open end of the cylindrical body comprises a threaded neck for engaging the threaded inner surface to secure the removable top and the cylindrical body.

6. The infant feeding container of claim 1, wherein the removable top further comprises a rigid threaded neck with a flange, the dome shaped portion having a lower portion around the flange.

7. The infant feeding container of claim 6, wherein the top open end of the cylindrical body comprises an inner threaded surface for engaging the threaded neck to secure the removable top and the cylindrical body.

8. The infant feeding container of claim 1, wherein the removable bottom cap comprises a threaded inner surface and the bottom open end of the cylindrical body comprises a threaded neck for engaging the threaded inner surface to secure the removable bottom cap and the cylindrical body.

9. The infant feeding container of claim 8, wherein the removable bottom cap comprises a cap body and a cap seal in the cap body.

10. The infant feeding container of claim 9, wherein the cap seal comprises a valve opposite of a vent in the cap body.

11. The infant feeding container of claim 1, wherein the removable top is a threaded screw top, the removable bottom cap is a threaded screw cap, the top and the bottom open ends of the cylindrical body comprise top and bottom threaded necks for engaging the threaded screw top and the threaded screw cap.

12. The infant feeding container of claim 1, wherein the removable top comprises a first threaded neck, the top open end of the cylindrical body comprises a threaded inner surface for engaging the first threaded neck, the bottom open end of the cylindrical body comprises a second threaded neck, and the removable bottom cap comprises a threaded screw cap for engaging the second threaded neck.

13. The infant feeding container of claim 1, further comprising:
a cover for engaging an outer surface of the removable top.

14. The infant feeding container of claim 13, wherein the cover further comprises an inner surface that forms a nipple cap for engaging the nipple to prevent liquid flow.

15. A method for assembling an infant feeding container comprising a cylindrical body defining top and bottom open ends, a removable top, and a removable bottom cap, the removable top comprising a pliant dome shaped portion with a ducted nipple, the method comprising:
securing the removable top to the top open end of the cylindrical body; and
securing the removable bottom cap to the bottom open end of the cylindrical body.

16. The method of claim 15, further comprising:
interchanging an other removable top for the removable top, the other removable top comprising a drinking spout and a valve coupled to the drinking spout.

17. The method of claim 15, further comprising:
interchanging an other removable top for the removable top, the other removable top comprising a passage for receiving a straw.

18. The method of claim 15, wherein securing the removable top and the removable bottom cap comprising screwing the removable top and the removable bottom cap to the top and the bottom open ends, respectively.

19. The method of claim 15, further comprising covering an outer surface of the removable top and sealing the nipple with a cover.

20. An infant feeding container for providing a feeding experience that closely resembles natural breast feeding, the infant feeding container comprising:
a rigid cylindrical body, the cylindrical body defining top and bottom open ends;
a removable top comprising a pliant dome shaped portion having a ducted nipple, the top engaging the top open end of the cylindrical body;
a removable bottom cap comprising a valve, the bottom cap engaging the bottom open end of the cylindrical body; and
a cover for engaging an outer surface of the top, the cover comprising an inner surface that forms a nipple cap for engaging the nipple to prevent liquid flow.
